(19) United States
(12) Patent Application Publication
(10) Pub. No.: US 2015/0120575 A1
(43) Pub. Date: Apr. 30, 2015

(54) METHOD AND APPARATUS FOR COUPON NEGOTIATION AND AUTHENTICATION

(71) Applicants: Dhaval Jitendra Joshi, Bangalore (IN); Hao Yang, San Jose, CA (US)

(72) Inventors: Dhaval Jitendra Joshi, Bangalore (IN); Hao Yang, San Jose, CA (US)

(73) Assignee: Nokia Corporation, Espoo (FI)

(21) Appl. No.: 14/398,196

(22) PCT Filed: May 15, 2012
(86) PCT No.: PCT/CN2012/075535

§ 371 Date: Dec. 8, 2014

(51) Int. Cl. G06Q 30/02

(52) U.S. Cl. CPC G06Q 30/0257
USPC 705/80

(57) ABSTRACT

An approach is provided for negotiating and authenticating coupons. A coupon management platform receives a request for determining a first offer information associated with at least one first coupon. The coupon management platform processes and/or facilitates a processing of the first offer information against one or more negotiation rules to determine at least one second coupon. The coupon management platform further causes, at least in part, a presentation of the at least one second coupon, second offer information associated with the at least one second coupon, or a combination thereof.

### BACKGROUND

Service providers and device manufacturers (e.g., wireless, cellular, etc.) are continually challenged to deliver value and convenience to consumers by, for example, providing compelling network services. Such services can often include shopping services and/or related marketing services. One area of interest has been the development of services that facilitate distribution and marketing of promotions or discounts (e.g., coupons or other similar discount offers) provided by vendors (e.g., retailers, service providers, third parties, etc.) to users. For example, vendors may spam potential users hoping that some of the users will like and will redeem the coupons at some point. As a result, coupons and related discount offers have proliferated, making it difficult for users to discover coupons and discounts of interest and for the vendors to discover and acquire new users/consumers. Accordingly, service providers and device manufacturers face significant technical challenges for enabling users to efficiently discover and utilize coupons and for vendors to effectively distribute their offers and coupons.

### Some Example Embodiments

Therefore, there is a need for an approach for negotiating and authenticating coupons.

According to one embodiment, a method comprises determining a first offer information associated with at least one first coupon. The method also comprises processing and/or facilitating a processing of the first offer information against one or more negotiation rules to determine at least one second coupon. The method further comprises causing, at least in part, a presentation of the at least one second coupon, second offer information associated with the at least one second coupon, or a combination thereof.

According to another embodiment, an apparatus comprises at least one processor and at least one memory including computer program code for one or more programs, the at least one memory and the computer program code configured to, with the at least one processor, cause the apparatus to determine first offer information associated with at least one first coupon. The apparatus is also caused to process and/or facilitate a processing of the first offer information against one or more negotiation rules to determine at least one second coupon. The apparatus is further caused to cause, at least in part, a presentation of the at least one second coupon, second offer information associated with the at least one second coupon, or a combination thereof.

According to another embodiment, a computer-readable storage medium carries one or more sequences of one or more instructions which, when executed by one or more processors, cause, at least in part, an apparatus to determine first offer information associated with at least one first coupon. The apparatus is also caused to process and/or facilitate a processing of the first offer information against one or more negotiation rules to determine at least one second coupon. The apparatus is further caused to cause, at least in part, a presentation of the at least one second coupon, second offer information associated with the at least one second coupon, or a combination thereof.

According to another embodiment, an apparatus comprises means for determining first offer information associated with at least one first coupon. The apparatus also comprises means for processing and/or facilitating a processing of the first offer information against one or more negotiation rules to determine at least one second coupon. The apparatus further comprises means for causing, at least in part, a presentation of the at least one second coupon, second offer information associated with the at least one second coupon, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-20, and 36-38.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of negotiating and authenticating coupons, according to an embodiment;

FIG. 2 is a diagram of the components of user equipment capable of coupon negotiations and authentication, according to an embodiment;

FIG. 3 is a diagram of the components of a coupon management platform, according to an embodiment;

FIG. 4 is a flowchart of a process for processing a first coupon and negotiating for one or more subsequent coupons, according to an embodiment;

FIG. 5 is a flowchart of a process for analyzing coupons and/or offers, according to an embodiment;

FIG. 6 is a flowchart of a process for invalidation, validation, and authentication of a coupon, according to an embodiment;

FIG. 7 is a time sequence diagram illustrating communications between a user, a coupon management platform, and one or more vendors, according to an embodiment;

FIGS. 8A-8F are diagrams and user interface examples utilized in coupon rules and negotiation processes, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for negotiating and authenticating coupons. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein the term “coupon” refers to a document, file, token, etc. that can be presented to receive a discount or rebate related to a transaction for goods and/or services. Although various embodiments are discussed with respect to negotiating and authenticating coupons, it is contemplated that the embodiments of the negotiating and authenticating process described herein are also applicable to any offers that can be negotiated and/or authenticated between users and/or vendors (e.g., service providers) including, but not limited, to physical and/or electronic coupons/offers for goods, services, other items in commerce, and the like.

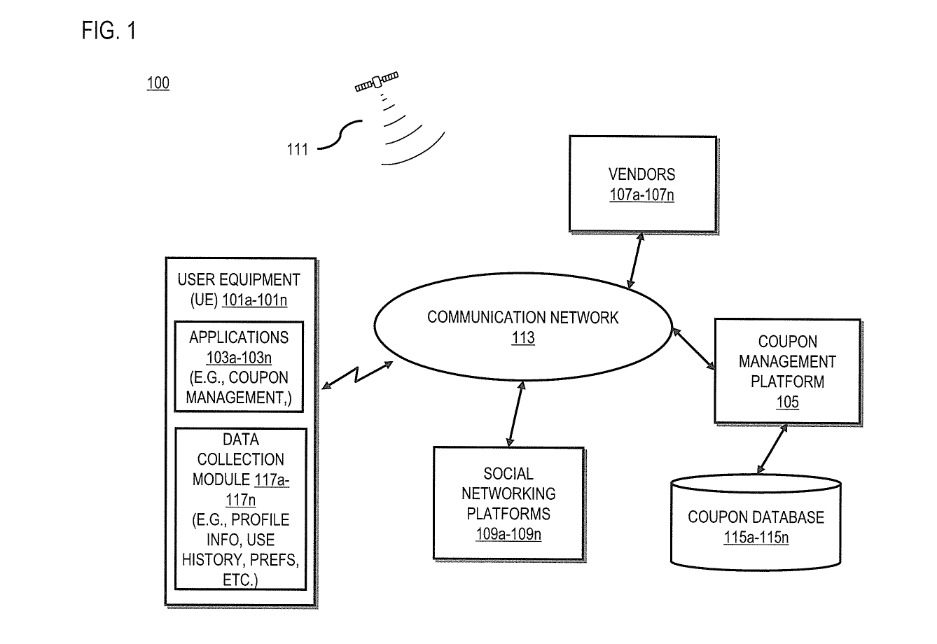

FIG. 1 is a diagram of a system capable of negotiating and authenticating coupons, according to an embodiment. As user coupons, incentives, and special offers are increasingly becoming more popular with users, vendors, and coupon service providers (e.g., retailers, service providers, merchants, etc.) are utilizing various mediums such as print media, internet, and mobile service platforms to distribute coupons (e.g., physical and electronic) and other offers to the users for advertising and promoting their products and services, whereby acquiring new users/customers and/or maintaining customer loyalty. However, at least one major challenge for the vendors and the coupon service providers is that user acquisition can be very challenging, especially when acquiring new users. For example, many vendors invest significant resources (e.g., time, money, personnel, etc.) for promoting their products and services essentially to same users (e.g., same target groups) in a marketplace. Traditionally, vendors (e.g., fast-food purveyors) may spam potential users with coupons (e.g., special offers) while hoping that some of the users will like and will eventually redeem those coupons. However, coupons often have limitations or other conditions with respect to, for instance, which vendors will accept the coupons, validity period, applicable products, vendor location, etc. Further, with a significant number of possible vendors and coupons in a given marketplace, it is often the case that a user has a coupon that the user does not intend to use, cannot use (e.g., before the coupon becomes invalid), would like to exchange the coupon for a different one (e.g., for a different vendor), and/or negotiate for better terms (e.g., better offer). Furthermore, if a user and/or a vendor wish to exchange and/or negotiate a coupon, a vendor has to be able to authenticate a coupon (e.g., of another vendor) before accepting, exchanging and/or negotiating the coupon. Therefore, there is a need for a mechanism for users and vendors to be able to authenticate and/or negotiate coupons.

To address, at least these problems, a system 100 of FIG. 1 introduces the capability to negotiate and authenticate coupons. More specifically, the system 100 supports users in utilizing a first coupon (e.g., an offer, an incentive, etc.) to negotiate and seek a better, different, and/or a comparable coupon from various vendors (e.g., a different vendor and/or the vendor of the first coupon). For example, a user may wish to utilize a first coupon (e.g., at a first restaurant) to negotiate for a better second coupon (e.g., higher discount, more products, etc.) from the same vendor as the first coupon, or negotiate for a similar coupon available from a different vendor (e.g., a different restaurant than the first restaurant). Additionally, the system 100 can support vendors in competing for, acquiring, and/or maintaining user/customer loyalty by offering a better and/or a more interesting coupon to the user. For example, a first vendor may issue a coupon to a user; one or more other vendors may negotiate and offer/issue one or more better coupons to the user; the first vendor may have an opportunity to make a counter-offer based, at least in part, on the one or more coupons offered by the one or more other vendors. Moreover, the vendors in the system 100 may have an opportunity to ascertain current competitor and market conditions via the coupons that the users may wish to utilize in their negotiations. Further, the system 100 may provide cross-vendor coupon authentication services to the vendors. For example, a user may present a first coupon issued by a first vendor to a second vendor (e.g., for redemption, for exchange, for negotiation, etc.), wherein the second vendor may not be able to authenticate the first coupon (e.g., was issued by a different vendor, by a third party, etc.) for lack of sufficient information (e.g., authentication codes, secret codes, etc.) on the first coupon and/or on the first vendor.

As shown in FIG. 1, in one embodiment, the system 100 includes user equipment (UE) 101a-101n (also collectively referred to as UE 101 and/or UEs 101), which may be utilized to execute one or more applications 103a-103n (also collectively referred to as applications 103) (e.g., coupon management, games, social networking, a web browser, a media application, user interface (UI), GPS, a map application, a web client, etc.) to communicate with other UEs 101, a coupon management platform 105, one or more vendors 107a-107n (also collectively referred to as vendors 107), one or more social networking platforms 109a-109n (also collectively referred to as social networking platforms 109), GPS satellite 111, and/or with other components of a communication network 113 directly and/or over the communication network 113. In one embodiment, the coupon management platform 105 may include and/or have access to one or more coupon database 115a-115n (also collectively referred to as coupon database 115), which may include various coupons, rules, authentication codes, secret codes, user information, and the like that may be associated with one or more vendors, coupon providers, one or more users, and/or other service providers (e.g., content providers, social networking, etc.) In one embodiment, the UEs 101 may include data collection modules 117a-117n (also collectively referred to as data collection module 117) for determining and/or collecting data associated with the UEs 101, one or more users of the UEs 101, applications 103, one or more content items, and the like.

In various embodiments, the coupon management platform 105 may include, retrieve, and/or have access to various coupons, coupon information, coupon templates, coupon rules, and the like from the one or more vendors, one or more users, one or more service providers (e.g., third party coupon providers, social networking platform 109, etc.), and the like for utilization in negotiating, exchanging, authenticating, and/or in creating the various coupons, coupon information, coupon templates, coupon rules, and the like. In one embodiment, the coupon management platform 105 may utilize user data (e.g., user profile, user preference, user context information, etc.) provided by the UE 101 data collection module 117 and/or the social networking platform 109 for the negotiating, exchanging, authenticating, creating, specifying, and the like the various coupons. In one embodiment, the coupon management platform 105 may determine and/or may have access to categorical information (e.g., type, category, etc.) associated with the vendors, products, services, and/or the coupons and may categorize the one or more coupons, the one or more rules, the one or more vendors, and the like, wherein the categorical information may be stored in a data structure (e.g., a tree) and include one or more subcategories.

In various embodiments, the vendors 107 include one or more physical business establishments, online product/service providers (e.g., online shopping), third party product/service providers, and the like. In one embodiment, the vendors 107 may have direct access to the coupon management platform 105 and/or to the coupon database 115, for example, to provide updates. In certain examples, the vendors 107 may provide (e.g., upload) information about products and services associated with a retail store, and related discount or coupon information. In certain embodiments, the coupons, coupon information, coupon rules, coupon templates, and the like may be locally defined, stored, and/or controlled by the vendors 107, while providing access to the coupon management platform 105 and/or other service providers.

In one embodiment, profile information, coupon use history, preferences, coupon criteria, etc. as well as context information about a user and/or a UE 101 may be collected and/or monitored at the coupon management platform 105 and/or at the UE 101. In certain embodiments, the applications 103 on the UE 101 can monitor the information (e.g., context data, user preferences, user criteria, user history, etc.) associated with the data collection module 117 of the UE 101. For example, the data collection module 117 may utilize applications, services, sensors, etc. to collect such information. Further, the context information can be any one of multiple types of information that can provide conditions that a user may use to specify one or more context-based coupon negotiations. Context information may include, for instance, location information, camera information, microphone information, environmental sensor information, weather information, user calendar information, accelerometer information, compass information, body temperature information, etc. In one embodiment, the data collection module 117 may have connectivity to a location determination sensor system, such as a Global Positioning System (GPS) to access GPS satellites 111 to determine context information (e.g., the location of the UE 101). The UE 101 may then cause transmission of the collected information (e.g., the profile information, discount use history, preferences, context information, etc.) to the coupon management platform 105 for processing to facilitate a context-based coupon negotiation. In one embodiment, the coupon management platform 105 can receive and store the information in a user profile associated with the user at a remote and/or at a local data storage. In certain embodiments, the user profile may include an identifier of the user (e.g., a username) and/or an identifier of the UE 101 (e.g., a hardware identifier such as an International Mobile Equipment Identity (IMEI), a phone number, an Internet Protocol address, etc.).

In one embodiment, the coupon management platform 105 determines a first offer information associated with at least one first coupon. In one embodiment, a service provider may receive one or more receives one or more coupons and/or information associated with the one or more coupons from a user who may wish to negotiate one or more terms of the one or more coupons, wherein the one or more coupons may be in electronic form, an image of a physical coupon (e.g., a picture of a print coupon), barcode information of a coupon (e.g., an image of the barcode, barcode information determined by a device, etc.), and the like. In one embodiment, the first offer information may include coupon information determined by a service provider, a user and/or a device, wherein the information may be included in an offer and/or via a coupon information template where the coupon information can be standardized for easier processing without using complex parsing and/or recognition of the coupon. In cases where no template is available for a particular coupon, the user may specify a new template or may provide the coupon information as free text.

In one embodiment, the coupon management platform 105 processes the first offer information against one or more negotiation rules to determine at least one second coupon. For example, a user wishes to negotiate location of a vendor where a coupon may be used (e.g., in a different city, near city center, etc.), or to exchange the coupon for a similar and/or a better coupon (e.g., more discount) from a different vendor, from the first coupon vendor (e.g., original vendor), and the like. In one embodiment, the coupon management platform 105 processes the first coupon and/or coupon information (e.g., a coupon template listing one or more coupon information items) to determine terms, conditions, information, and the like (e.g., discount amount, vendor, location, applicable products and/or services, etc.) associated with the first coupon. Further, the service provider utilizes one or more information items from the processed coupon to compare with one or more rules for determining one or more other coupons, wherein the rules may be specified by a vendor associated with the first coupon, by one or more other vendors, by one or more other service providers, by one or more other users, and the like. For example, a rule may provide for one or more second coupons similar (e.g., similar product, service, value, etc.) to the first coupon offered by one or more different vendors. In one example, the vendor of the first coupon may offer a second coupon having a better value, at a different location, for a different product or service, and the like.

In one embodiment, coupon management platform 105 causes a presentation of the at least one second coupon, second offer information associated with the at least one second coupon, or a combination thereof. In one embodiment, a coupon management platform 105 and/or a service provider (e.g., a coupon service platform) may present and/or cause a presentation of the one or more second coupons to a user at a device, for the user's review and consideration, wherein the presentation may provide one or more actual second coupons, information associated with the one or more second coupons, one or more links associated with the one or more second coupons and/or vendors, and the like, wherein the presentation may be as a list, on a map application, via SMS, and the like.

In one embodiment, the coupon management platform 105 processes the second offer information against one or more renegotiation rules associated with the at least one first coupon to determine at least one third coupon associated with at least one first vendor, at least one first user, or a combination thereof associated with the at least one first coupon. In one embodiment, the coupon management platform 105 may process the second offer (e.g., a coupon) and/or information associated with the second offer and compare with one or more renegotiation rules associated with the first offer and/or the second offer for determining one or more subsequent (e.g., third) coupons associated with the first vendor and/or a first user. For example, the coupon management platform 105 may utilize a first offer by a first vendor and one or more rules to negotiate one or more second offers available from one or more other vendors and then, utilize the second offer and one or more renegotiation rules (e.g., from one or more vendors) for determining one or more third offers available from the first vendor and/or from one or more other vendors.

In one embodiment, the coupon management platform 105 processes the first offer information to determine a first offer value associated with the at least one first coupon. In one embodiment, a service provider may determine one or more values from a first offer information (e.g., template information) and/or a first coupon (e.g., actual coupon). For example, the one or more values may indicate a discount amount in a currency (e.g., one dollar off), a percentage discount off a purchase (e.g., 15% off total purchase amount), product offers (e.g., buy one get one free), and the like. In one embodiment, value associated with the first offer and/or the first coupon may be determined based on a formula, an algorithm, user information, location information, vendor information, and the like.

In one embodiment, the coupon management platform 105 processes the second offer information to determine a second offer value with the at least one second coupon. In one embodiment, a service provider may determine one or more values from a second offer information (e.g., template information) and/or a second coupon. In one embodiment, the coupon management platform 105 may utilize a first offer value, a second offer value and one or more negotiation rules for determining one or more second coupons. For example, the coupon management platform 105 determines that a first offer has a value of $1.00 and a second offer has a value of $1.25 and based on one or more negotiation rules (e.g., by one or more vendors, by a user, etc.), the coupon management platform 105 can negotiate for a second coupon and/or a subsequent coupon.

In one embodiment, the coupon management platform 105 determines at least one category associated with the at least one first coupon. In one embodiment, the coupon management platform 105 may determine and/or utilize offer information associated with one or more coupons for categorizing the one or more coupons, for example, according to type of service/product, vendor, value (e.g., percentage off, amount off, free products, etc.,), location, ratings, rankings, vendor association (e.g., with certain organizations), and the like. In one embodiment, a service provider may utilize category information of a coupon for negotiating and/or determining one or more one second coupons. For example, a service provider may determine that a first coupon (e.g., 25% off purchase) is for fast-food products (e.g., burgers) at a local vendor, wherein the first coupon may be at least categorized as “percentage off, fast-food, burgers, local vendor,” wherein a second coupon may be determined/negotiated based, at least in part, on the category information.

In one embodiment, the coupon management platform 105 determines contextual information, user preference information, profile information, or a combination thereof associated with a device, a user of the device, or a combination thereof that is presenting the at least one first coupon. In one embodiment, contextual information may be presented by a user and/or a device, wherein the contextual information may specify one or more attributes associated with the user, device, and/or a coupon. For example, the contextual information may describe a particular characteristic of the coupon (e.g., a product, a discount amount, etc.), location of the user/device, user associations (e.g., membership in a social network, member of a shopping club, etc.), gender and age of the user, product preferences (e.g., eco-friendly, organic, etc.), vendor preferences (e.g., small shops, super stores, within 0.5 mile, etc.), wherein the coupon management platform 105 may utilize the contextual information, the user preference information, the profile information, or a combination thereof for determining one or more second coupons.

In one embodiment, the coupon management platform 105 causes an invalidation of the at least one first coupon based, at least in part, on the one or more negotiation rules, an acceptance of the at least one second coupon, or a combination thereof. In one embodiment, one or more negotiation rules by one or more vendors, service providers, coupon platforms, and the like may require that a upon a user accepting the one or more second coupons and/or subsequent offers, the one or more first coupons of the user need to be invalidated. For example, a user negotiates a first coupon for one or more second coupons; receives and accepts one or more coupons and/or offers; the first coupon needs to be invalidated (e.g., released, void, exchanged, turned it.), wherein the coupon management platform 105 may substantially automatically (e.g., utilize one or more applications 103, one or more algorithms, one or more software options, etc.)

In one embodiment, the coupon management platform 105 determines one or more codes, one or more identifiers, or a combination thereof associated with the at least one first coupon, the at least one second coupon, or a combination thereof. In one embodiment, the coupon management platform 105 may access, retrieve, and/or utilize one or more numerical and/or textual codes associated with one or more first coupons, information associated with the one or more first coupons, one or more second coupons, information associated with the one or more second coupons, and/or with subsequent coupons, and/or associated information. For example, the one or more codes may be determined from a coupon information template, barcode information, an image of a coupon, secret codes, and the like, wherein the codes may be provided by one or more vendors, one or more coupon platforms, one or more users providing one or more coupons, and the like.

In one embodiment, the coupon management platform 105 causes an authentication of the at least one first coupon, the at least one second coupon, or a combination thereof based, at least in part, on the one or more codes, the one or more identifiers, or a combination thereof. In one embodiment, the coupon management platform 105 may utilize the one or more determined codes to authenticate one or more first coupons, one or more second coupons and/or one or more subsequent coupons presented by one or more users, one or more vendors, and/or one or more other service providers.

In one embodiment, the coupon management platform 105 causes, at least in part, an initiation of the authentication based, at least in part, on at least one request to redeem the at least one first coupon, the at least one second coupon, or a combination thereof. In one embodiment, the coupon management platform 105 may initiate one or more authentication processes of one or more coupons (e.g., a first coupon, a second coupon, a third coupon, etc.) presented for redemption by one or more users, by one or more vendors. For example, the service provider may provide authentication services to one or more vendors wishing to authenticate one or more coupons associated with one or more other vendors, wherein the one or more vendors may or may not have access to authentication codes and/or processes.

By way of example, the communication network 113 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UEs 101 and coupon management platform 105 communicate with each other and other components of the communication network 113 using well known, new or still developing protocols. In this context, a protocol includes a set of rules defining how the network nodes within the communication network 113 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the coupon management platform 105 may interact according to a client-server model with the applications 103 of the UE 101. According to the client-server model, a client process sends a message including a request to a server process, and the server process responds by providing a service (e.g., context-based grouping, social networking, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

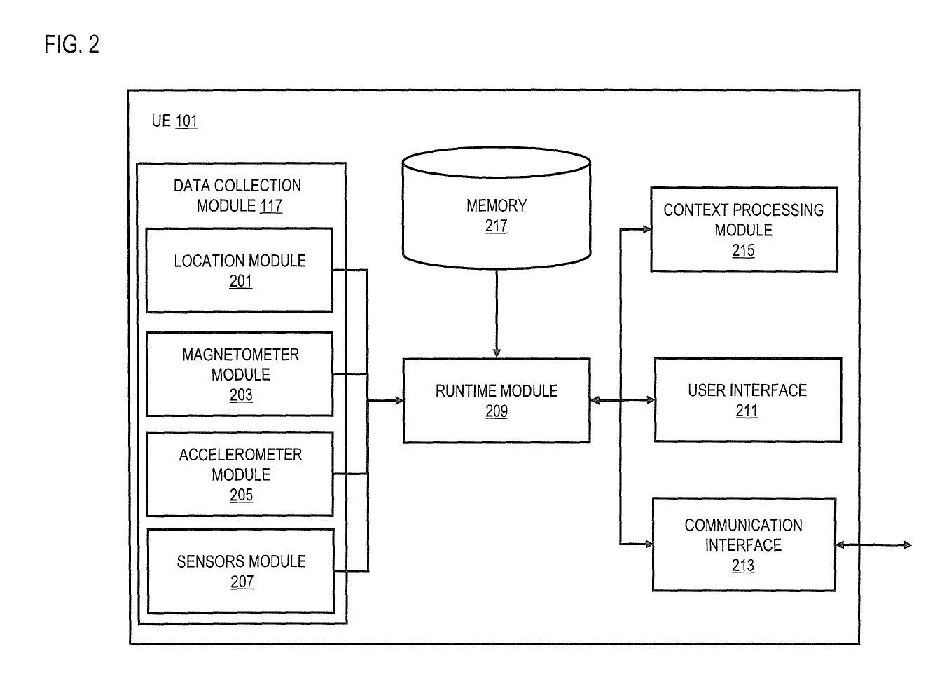

FIG. 2 is a diagram of the components of user equipment capable of coupon negotiations and authentication, according to an embodiment. By way of example, a UE 101 includes one or more components for negotiating and authenticating coupons. It is contemplated that the functions of these components may be combined in one or more components or performed by other components of equivalent functionality. In this embodiment, the UE 101 includes a data collection module 117 that may include one or more location modules 201, magnetometer modules 203, accelerometer modules 205, and sensors modules 207. Further, the UE 101 may also include a runtime module 209 to coordinate the use of other components of the UE 101, a user interface 211, a communication interface 213, a context processing module 215, and memory 217. The applications 103 (e.g., a coupon management application) of the UE 101 can execute on the runtime module 209 utilizing the components of the UE 101.

The location module 201 can determine a user's location. The user's location can be determined by a triangulation system such as GPS, assisted GPS (A-GPS), Cell of Origin, or other location extrapolation technologies. Standard GPS and A-GPS systems can use satellites 111 to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 201 may also utilize multiple technologies to detect the location of the UE 101. Location coordinates (e.g., GPS coordinates) can give finer detail as to the location of the UE 101 when media is captured. In one embodiment, GPS coordinates are stored as context information in the memory 217 and are transmitted to the coupon management platform 105 and/or other service providers via the communication interface 213. Moreover, in certain embodiments, the GPS coordinates can include an altitude to provide a height. In other embodiments, the altitude can be determined using another type of altimeter. In certain embodiments, the location module 201 can be a means for determining a location of the UE 101, an image, or used to associate an object in view with a location.

The magnetometer module 203 can be used in finding horizontal orientation of the UE 101. A magnetometer is an instrument that can measure the strength and/or direction of a magnetic field. Using the same approach as a compass, the magnetometer is capable of determining the direction of a UE 101 using the magnetic field of the Earth. The front of a media capture device (e.g., a camera) can be marked as a reference point in determining direction. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer can be stored in memory 217 and/or transmitted via the communication interface 213 to the coupon management platform 105 and/or other service providers.

The accelerometer module 205 can be used to determine vertical orientation of the UE 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a UE 101 is stationary, the accelerometer module 205 can determine the angle the UE 101 is pointed as compared to Earth's gravity. In certain embodiments, the magnetometer module 203 and accelerometer module 205 can be means for ascertaining a perspective of a user. This perspective information may be stored in the memory 217 and sent to the coupon management platform 105 and/or other service providers.

In various embodiments, the sensors module 207 can determine environmental (e.g., atmospheric) conditions surrounding the UE 101, user mood (e.g., hungry, angry, tired, etc.), and the like. For example, the sensors module 207 may detect conditions including humidity, temperature, body temperature of the user, other biometric data of the user, etc. Once again, this information can be stored in the memory 217 and sent to the coupon management platform 105 and/or other service providers. In certain embodiments, information collected from the data collection module 117 can be retrieved by the runtime module 209 and stored in memory 217. Then, periodically, the information can be transmitted to the coupon management platform 105 and/or other service providers.

In one embodiment, the communication interface 213 can be used to communicate with the coupon management platform 105 or other UEs 101. Certain communications can be via methods such as an internet protocol, messaging (e.g., SMS, MMS, etc.), or any other communication method (e.g., via the communication network 113). In some examples, the UE 101 can send context information associated with the UE 101 to the coupon management platform 105. In other examples, the user can utilize a user interface 211 to generate a request for contributing and/or receiving coupon information based on context to send to the coupon management platform 105.

The user interface 211 can include various methods of communication. For example, the user interface 211 can have outputs including a visual component (e.g., a screen), an audio component, a physical component (e.g., vibrations), and other methods of communication. User inputs can include a touch-screen interface, a scroll-and-click interface, a button interface, a microphone, etc. Input can be via one or more methods such as voice input, textual input, typed input, typed touch-screen input, other touch-enabled input, etc.

The context processing module 215 may be utilized in determining context information from the data collection module 117 and/or applications 103 executing on the runtime module 209. This information may be caused to be transmitted, via the communication interface 213 to the coupon management platform 105 and/or to other entities of the system 100. The context processing module 215 may additionally be utilized as a means for determining coupon information based on input criteria and received context information associated with the user and/or the UE 101. In certain embodiments, the context processing module 215 can infer higher level context information from the context data such as favorite locations, significant places, common activities, interests in products and services, etc.

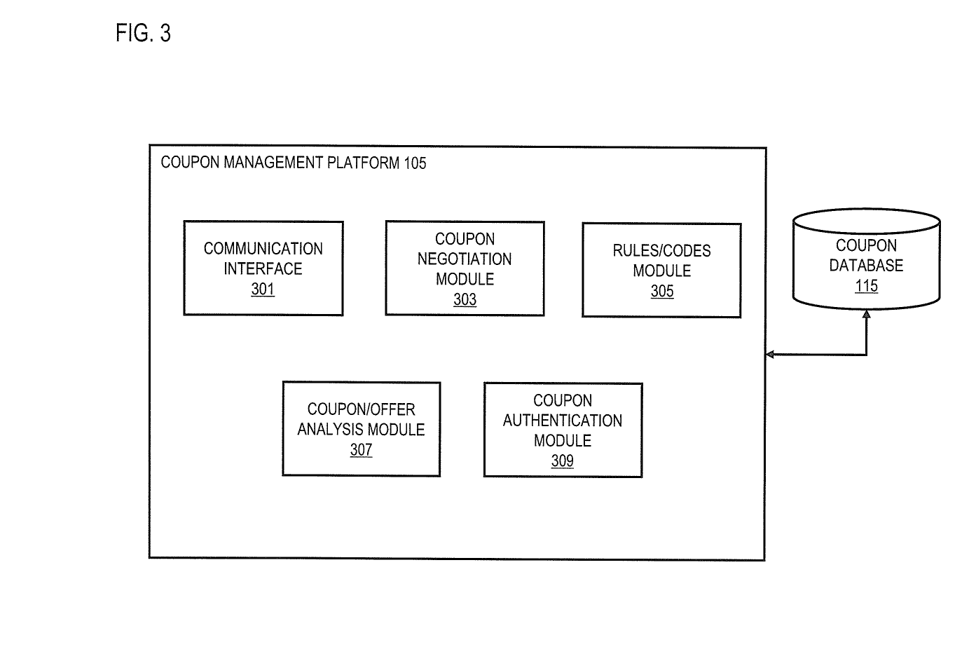

FIG. 3 is a diagram of the components of a coupon management platform, according to an embodiment. By way of example, the coupon management platform 105 includes one or more components for managing coupons and offers for users and vendors. It is contemplated that the functions of these components may be combined in one or more components or performed by other components of equivalent functionality. In this embodiment, the coupon management platform 105 includes a communication interface 301, a coupon negotiation module 303, a rules/codes module 305, a coupon/offer analysis module 307, and a coupon authentication module 309. It is contemplated that all or a portion of the functions of the coupon management platform 105 may also be performed by various service providers and/or the applications 103 of the UE 101.

In one embodiment, the communication interface 301 can be used to communicate with a UE 101 as well as other devices connected on the communication network 113. In one embodiment, the coupon management platform 105 may receive and/or request coupon information, user context information, user-specified templates, user profile information, vendor information (e.g., rules, offers, coupons, products/services information, etc.), and the like from the UE 101 and/or the vendors 107 via the communication interface 301 via methods such as internet protocol, MMS, SMS, GPRS, or any other available communication method. By way of example, the UE 101 and/or the vendors 107 may further send coupon negotiation requests, context-based matching results, coupon information, discounts, and related information to the coupon management platform 105 to access one or more coupon management functions (e.g., authentication, negotiation, sharing, etc.) for determining available coupons, determining participating vendors, updating user profiles, updating context data, etc. in the coupon database 115.

In one embodiment, the coupon negotiation module 303 may receive requests from users to check on availability of and/or to negotiate on one or more coupons available to the user. In one embodiment, the requests may include one or more coupons, coupon information (e.g., coupon information templates), offer information, user information (e.g., user profile, user preferences, user history, user location, desired location, etc.), coupon criteria (e.g., coupon category, a user gender, a user age, a user location, etc.), and the like. In one embodiment, the criteria are context-based. As noted previously, the coupon and/or offer information may be provided by the user in a template form, wherein the template information may be provided by the user and/or the applications 103. For example, the user may input various parameters of a coupon that the user is interested to negotiate with one or more vendors. In one example, the applications 103 may determine all or portions of the coupon information from a coupon and/or an offer available to the user. In one embodiment, the coupon negotiation module 303 may interact with the rules module for determining one or more rules associated with one or more vendors, which may be applicable to a coupon and/or an offer presented by a user for negotiation with one or more vendors. In one embodiment, the coupon negotiation module 303 may provide information associated with a one or more coupons and/or offers to the coupon/offer analysis module 307 for analysis, comparison, recommendation, and the like.

In one embodiment, the rules/codes module 305 can receive, determine, and/or monitor one or more rules and/or codes associated with one or more vendors (e.g., participating in/member of the system 100) via the communication network 113. The rules/codes module 305 can poll for updates to the one or more rules and/or codes from the one or more vendors and/or the one or more vendors may update their respective one or more rules and/or codes. In one embodiment, the rules/codes module 305 may provide one or more rules information to the coupon/offer analysis module 307 for utilization in analysis of one or more coupons and/or offers associated with a user and/or one or more vendors. In one embodiment, the rules/codes module 305 may provide one or more codes (e.g., vendor secret codes) to the coupon authentication module 309 for utilization in authenticating one or more coupons associated with one or more users and/or one or more vendors.

In one embodiment, the coupon/offer analysis module 307 may process and/or analyze one or more coupons, offers, and/or information associate with the coupons and/or the offers. In one embodiment, the coupon/offer analysis module 307 may utilize one or more algorithms and/or software application to analyze (e.g., compare) various information associated with coupons and/or offers available from one or more vendors for determining potential values, advantages, disadvantages, criteria, requirements, conditions, terms, and the like associated with the coupons and/or offers. In one embodiment, the coupon/offer analysis module 307 may provide the analysis results to the coupon negotiation module 303 for utilization in negotiations of one or more coupons and/or offers. In one embodiment, the coupon/offer analysis module 307 may provide the analysis results to the communication interface 301 for presentation to one or more users. In one embodiment, the coupon/offer analysis module 307 may utilize the analysis results for providing one or more recommendations to a user associated with one or more coupons and/or offers. For example, the coupon/offer analysis module 307 may recommend for a user to select a coupon from a group of coupons available from one or more vendors, based on user information, user criteria, vendor information, coupon values, terms, conditions, and the like.

In one embodiment, the coupon authentication module 309 may partially or completely authenticate one or more coupons from one or more user and/or from one more vendors. For example, the coupon authentication module 309 may process one or more coupons for authentication before and/or after the coupon negotiation and/or the coupon/offer analysis processes. In one embodiment, the coupon authentication module 309 may provide cross-vendor coupon authentication services to the vendors. For example, a user may present a first coupon from a first vendor to a second vendor (e.g., for redemption, for exchange, for negotiation, etc.), wherein the second vendor may not be able to authenticate the first coupon (e.g., was issued by a different vendor, by a third party, etc.) for lack of sufficient information (e.g., authentication codes, secret codes, etc.) on the first coupon and/or on the first vendor.

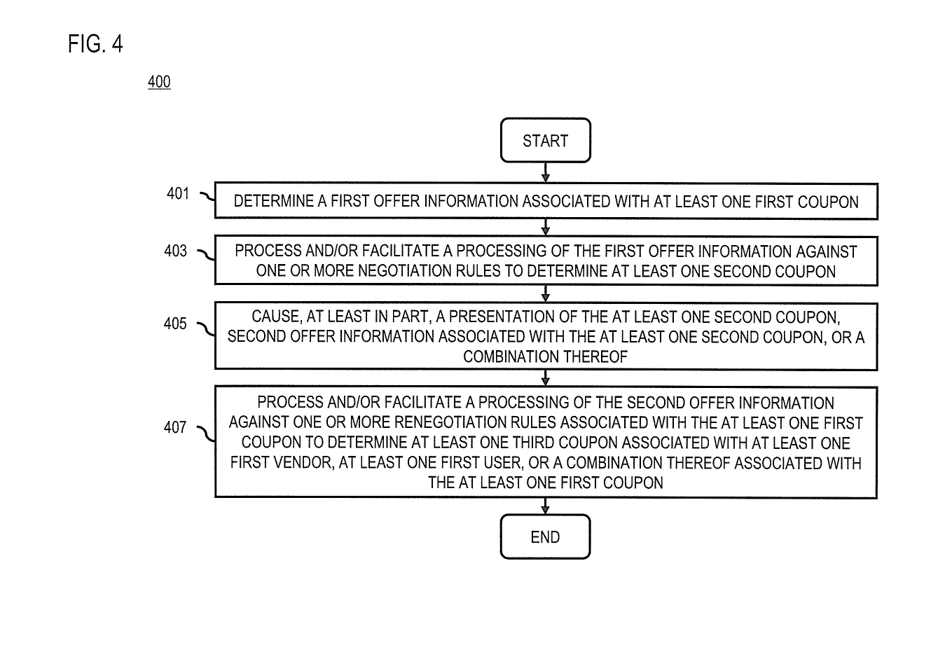

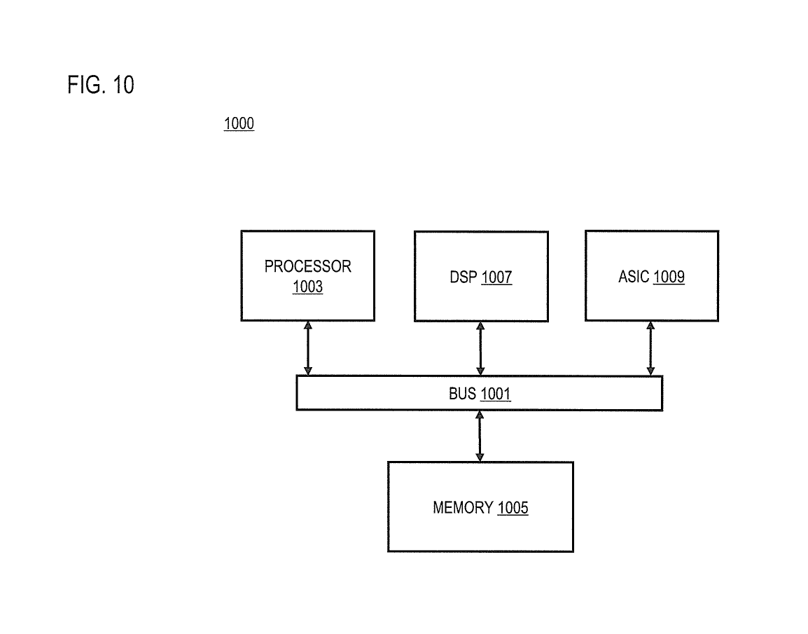

FIG. 4 is a flowchart of a process for processing a first coupon and negotiating for one or more subsequent coupons, according to an embodiment. In one embodiment, the coupon management platform 105 and/or applications 103 of the UE 101 performs the process 400 and is implemented in, for instance, a chip set including a processor and a memory as shown in FIG. 10. As such, the coupon management platform 105 and/or applications 103 can provide means for accomplishing various parts of the process 400 as well as means for accomplishing other processes in conjunction with other components of the system 100. Throughout this process, the coupon management platform 105 is referred to as completing various portions of the process 400, however, it is understood that the UE 101 can perform some of and/or all of the process steps.

In step 401, the coupon management platform 105 determines a first offer information associated with at least one first coupon. In one embodiment, coupon management platform 105 may receive one or more receives one or more coupons and/or information associated with the one or more coupons from a user who may wish to negotiate one or more terms of the one or more coupons, wherein the one or more coupons may be in electronic form, an image of a physical coupon (e.g., a picture of a print coupon), barcode information of a coupon (e.g., an image of the barcode, barcode information determined by a device, etc.), and the like. In one embodiment, the first offer information may include coupon information determined by a service provider, a user and/or a device, wherein the information may be included in an offer and/or via a coupon information template where the coupon information can be standardized for easier processing without using complex parsing and/or recognition of the coupon. In cases where no template is available for a particular coupon, the user may specify a new template or may provide the coupon information as free text.

In step 403, the coupon management platform 105 processes and/or facilitates a processing of the first offer information against one or more negotiation rules to determine at least one second coupon. For example, a user wishes to negotiate location of a vendor where a coupon may be used (e.g., in a different city, near city center, etc.), or to exchange the coupon for a similar and/or a better coupon (e.g., more discount) from a different vendor, from the first coupon vendor (e.g., original vendor), and the like. In one embodiment, the coupon management platform 105 processes the first coupon and/or coupon information (e.g., a coupon template listing one or more coupon information items) to determine terms, conditions, information, and the like (e.g., discount amount, vendor, location, applicable products and/or services, etc.) associated with the first coupon. Further, the service provider utilizes one or more information items from the processed coupon to compare with one or more rules for determining one or more other coupons, wherein the rules may be specified by a vendor associated with the first coupon, by one or more other vendors, by one or more other service providers, by one or more other users, and the like. For example, a rule may provide for one or more second coupons similar (e.g., similar product, service, value, etc.) to the first coupon offered by one or more different vendors. In one example, the vendor of the first coupon may offer a second coupon having a better value, at a different location, for a different product or service, and the like.

In step 405, the coupon management platform 105 causes, at least in part, a presentation of the at least one second coupon, second offer information associated with the at least one second coupon, or a combination thereof. In one embodiment, a coupon management platform 105 and/or a service provider (e.g., a coupon service platform) may present and/or cause a presentation of the one or more second coupons to a user at a device, for the user's review and consideration, wherein the presentation may provide one or more actual second coupons, information associated with the one or more second coupons, one or more links associated with the one or more second coupons and/or vendors, and the like, wherein the presentation may be as a list, on a map application, via SMS, and the like.

In step 407, the coupon management platform 105 processes and/or facilitates a processing of the second offer information against one or more renegotiation rules associated with the at least one first coupon to determine at least one third coupon associated with at least one first vendor, at least one first user, or a combination thereof associated with the at least one first coupon. In one embodiment, the coupon management platform 105 may process the second offer (e.g., a coupon) and/or information associated with the second offer and compare with one or more renegotiation rules associated with the first offer and/or the second offer for determining one or more subsequent (e.g., third) coupons associated with the first vendor and/or a first user. For example, the coupon management platform 105 may utilize a first offer by a first vendor and one or more rules to negotiate one or more second offers available from one or more other vendors and then, utilize the second offer and one or more renegotiation rules (e.g., from one or more vendors) for determining one or more third offers available from the first vendor and/or from one or more other vendors.

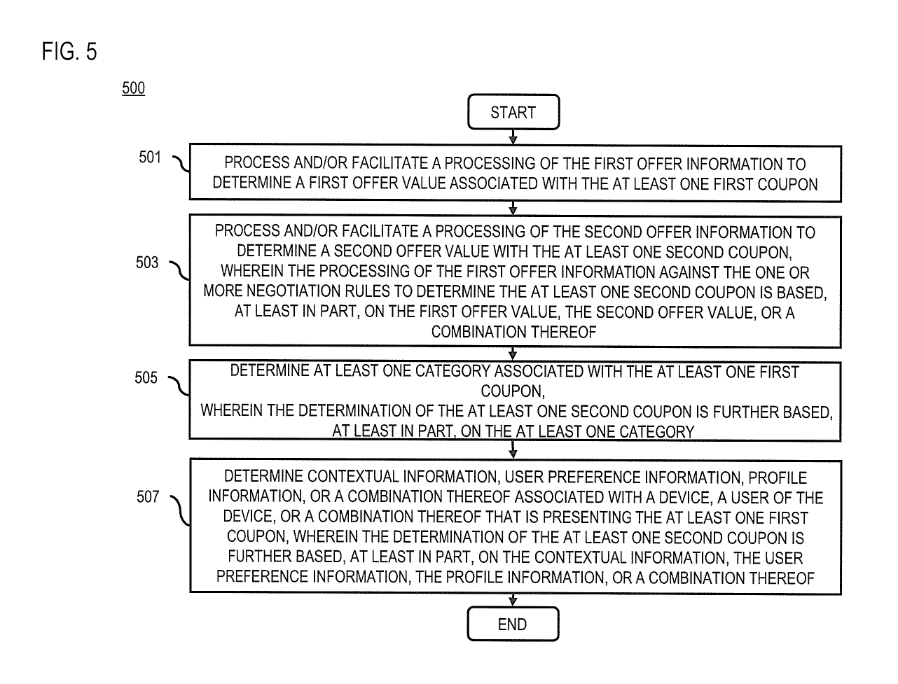

FIG. 5 is a flowchart of a process for analyzing coupons and/or offers, according to an embodiment. In one embodiment, the coupon management platform 105 and/or applications 103 of the UE 101 performs the process 500 and is implemented in, for instance, a chip set including a processor and a memory as shown in FIG. 10. As such, the coupon management platform 105 and/or applications 103 can provide means for accomplishing various parts of the process 500 as well as means for accomplishing other processes in conjunction with other components of the system 100. Throughout this process, the coupon management platform 105 is referred to as completing various portions of the process 500, however, it is understood that the UE 101 can perform some of and/or all of the process steps.

In step 501, the coupon management platform 105 processes and/or facilitates a processing of the first offer information to determine a first offer value associated with the at least one first coupon. In one embodiment, a service provider may determine one or more values from a first offer information (e.g., template information) and/or a first coupon (e.g., actual coupon). For example, the one or more values may indicate a discount amount in a currency (e.g., one dollar off), a percentage discount off a purchase (e.g., 15% off total purchase amount), product offers (e.g., buy one get one free), and the like. In one embodiment, value associated with the first offer and/or the first coupon may be determined based on a formula, an algorithm, user information, location information, vendor information, and the like.

In step 503, the coupon management platform 105 processes and/or facilitates a processing of the second offer information to determine a second offer value with the at least one second coupon, wherein the processing of the first offer information against the one or more negotiation rules to determine the at least one second coupon is based, at least in part, on the first offer value, the second offer value, or a combination thereof. In one embodiment, a service provider may determine one or more values from a second offer information (e.g., template information) and/or a second coupon. In one embodiment, the coupon management platform 105 may utilize a first offer value, a second offer value and one or more negotiation rules for determining one or more second coupons. For example, the coupon management platform 105 determines that a first offer has a value of $1.00 and a second offer has a value of $1.25 and based on one or more negotiation rules (e.g., by one or more vendors, by a user, etc.), the coupon management platform 105 can negotiate for a second coupon and/or a subsequent coupon.

In step 505, the coupon management platform 105 determining at least one category associated with the at least one first coupon, wherein the determination of the at least one second coupon is further based, at least in part, on the at least one category. In one embodiment, the coupon management platform 105 may determine and/or utilize offer information associated with one or more coupons for categorizing the one or more coupons, for example, according to type of service/product, vendor, value (e.g., percentage off, amount off, free products, etc.), location, ratings, rankings, vendor association (e.g., with certain organizations), and the like. In one embodiment, a service provider may utilize category information of a coupon for negotiating and/or determining one or more one second coupons. For example, a service provider may determine that a first coupon (e.g., 25% off purchase) is for fast-food products (e.g., burgers) at a local vendor, wherein the first coupon may be at least categorized as “percentage off, fast-food, burgers, local vendor,” wherein a second coupon may be determined/negotiated based, at least in part, on the category information.

In step 507, the coupon management platform 105 determining contextual information, user preference information, profile information, or a combination thereof associated with a device, a user of the device, or a combination thereof that is presenting the at least one first coupon, wherein the determination of the at least one second coupon is further based, at least in part, on the contextual information, the user preference information, the profile information, or a combination thereof. In one embodiment, contextual information may be presented by a user and/or a device, wherein the contextual information may specify one or more attributes associated with the user, device, and/or a coupon. For example, the contextual information may describe a particular characteristic of the coupon (e.g., a product, a discount amount, etc.), location of the user/device, user associations (e.g., membership in a social network, member of a shopping club, etc.), gender and age of the user, product preferences (e.g., eco-friendly, organic, etc.), vendor preferences (e.g., small shops, super stores, within 0.5 mile, etc.), wherein the coupon management platform 105 may utilize the contextual information, the user preference information, the profile information, or a combination thereof for determining one or more second coupons.

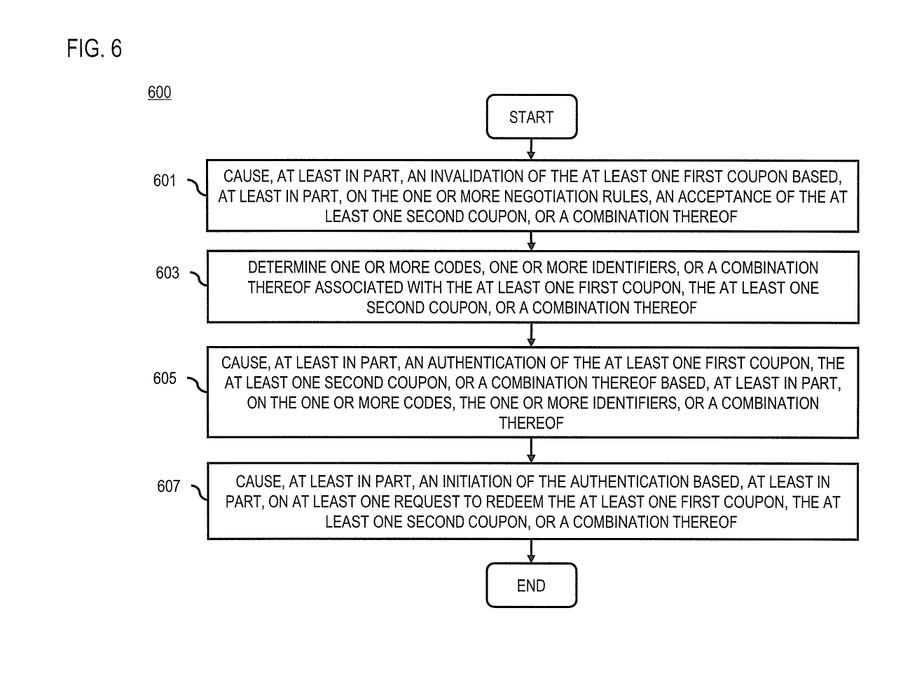

FIG. 6 is a flowchart of a process for invalidation, validation, and authentication of a coupon, according to an embodiment. In one embodiment, the coupon management platform 105 and/or applications 103 of the UE 101 performs the process 600 and is implemented in, for instance, a chip set including a processor and a memory as shown in FIG. 10. As such, the coupon management platform 105 and/or applications 103 can provide means for accomplishing various parts of the process 600 as well as means for accomplishing other processes in conjunction with other components of the system 100. Throughout this process, the coupon management platform 105 is referred to as completing various portions of the process 600, however, it is understood that the UE 101 can perform some of and/or all of the process steps.

In step 601, the coupon management platform 105 causes, at least in part, an invalidation of the at least one first coupon based, at least in part, on the one or more negotiation rules, an acceptance of the at least one second coupon, or a combination thereof. In one embodiment, one or more negotiation rules by one or more vendors, service providers, coupon platforms, and the like may require that a upon a user accepting the one or more second coupons and/or subsequent offers, the one or more first coupons of the user need to be invalidated. For example, a user negotiates a first coupon for one or more second coupons; receives and accepts one or more coupons and/or offers; the first coupon needs to be invalidated (e.g., released, void, exchanged, turned it.), wherein the coupon management platform 105 may substantially automatically (e.g., utilize one or more applications 103, one or more algorithms, one or more software options, etc.)

In step 603, the coupon management platform 105 determines one or more codes, one or more identifiers, or a combination thereof associated with the at least one first coupon, the at least one second coupon, or a combination thereof. In one embodiment, the coupon management platform 105 may access, retrieve, and/or utilize one or more numerical and/or textual codes associated with one or more first coupons, information associated with the one or more first coupons, one or more second coupons, information associated with the one or more second coupons, and/or with subsequent coupons, and/or associated information. For example, the one or more codes may be determined from a coupon information template, barcode information, an image of a coupon, secret codes, and the like, wherein the codes may be provided by one or more vendors, one or more coupon platforms, one or more users providing one or more coupons, and the like.

In step 605, the coupon management platform 105 causes, at least in part, an authentication of the at least one first coupon, the at least one second coupon, or a combination thereof based, at least in part, on the one or more codes, the one or more identifiers, or a combination thereof. In one embodiment, the coupon management platform 105 may utilize the one or more determined codes to authenticate one or more first coupons, one or more second coupons and/or one or more subsequent coupons presented by one or more users, one or more vendors, and/or one or more other service providers.

In step 607, the coupon management platform 105 causes, at least in part, an initiation of the authentication based, at least in part, on at least one request to redeem the at least one first coupon, the at least one second coupon, or a combination thereof. In one embodiment, the coupon management platform 105 may initiate one or more authentication processes of one or more coupons (e.g., a first coupon, a second coupon, a third coupon, etc.) presented for redemption by one or more users, by one or more vendors. For example, the service provider may provide authentication services to one or more vendors wishing to authenticate one or more coupons associated with one or more other vendors, wherein the one or more vendors may or may not have access to authentication codes and/or processes.

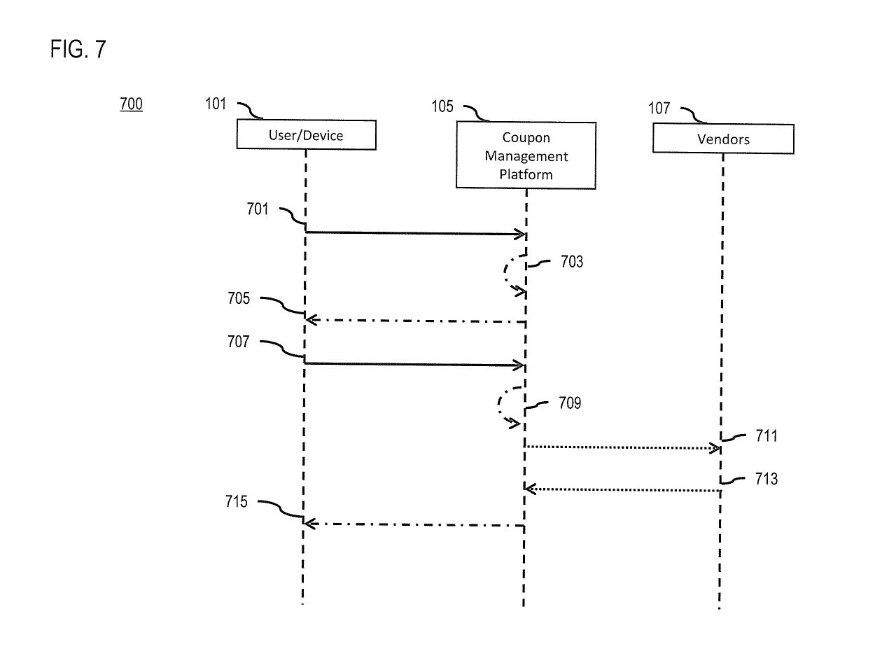

FIG. 7 is a time sequence diagram illustrating communications between a user, a coupon management platform, and one or more vendors, according to an embodiment. In one use scenario, in diagram 700, at 701 a user submits one or more requests (e.g., sends, transmits, etc.) to the coupon management platform 105 for negotiating one or more first coupons and/or first coupon/offer information, wherein the user may have obtained the one or more first coupons and/or the first coupon/offer information (e.g., electronic, physical) form one or more sources, for example, from one or more other users, vendors, coupon services, and the like. In one embodiment, the one or more first coupons and/or first coupon/offer information may be submitted as one or more coupons, via one or more coupon templates, as free text (e.g., handwritten, text message, etc.), as one or more images, barcode information, and the like. Further, at 703 the coupon management platform 105 processes the one or more requests, the one or more first coupons and/or the first coupon/offer information for determining one or more criteria associated with the user, the one or more first coupons and/or the first coupon/offer information.

Furthermore, the coupon management platform 105 compares the one or more criteria against one or more rules associated with one or more vendors and/or service providers for determining whether one or more other (e.g., second) coupons are available from one or more vendors (e.g., same vendor as a first coupon, a different vendor, another user, etc.) In one embodiment, the coupon management platform 105 determines one or more second coupons and/or offers and at 705 presents them to the user for user consideration. Moreover, at 707 the user reviews and considers the presented one or more second coupons and/or offers and wishes to further negotiate the one or more second coupons and/or offers so at 707 presents one or more requests to the coupon management platform 105 for renegotiating the one or more second coupons and/or offers.

In one embodiment, at 709 the coupon management platform 105 may review/re-evaluate the one or more second coupons and/or offers against one or more rules for potential renegotiations of the one or more second coupons and/or offers for one or more third coupons and/or offers. In one embodiment, at 711 the coupon management platform 105 may check with one or more vendors 107 to check for potential one or more third coupons and/or offers. In one embodiment, at 713 the one or more vendors 107 may present one or more third coupons, offers and/or one or more rules for renegotiating the one or more second coupons and/or offers. Further, at 715 the coupon management platform 105 presents back to the user the one or more second coupons, offers and/or one or more third coupons and/or offers (e.g., renegotiated).

In various embodiments, a user may present one or more coupons and/or coupon/offer information to the coupon management platform 105 for one or more negotiations until the user, the coupon management platform 105, one or more rules, one or more vendors, or a combination thereof, determines (e.g., decides, suggests, presents, etc.) a stopping of the negotiation process. For example, a user accepts a renegotiated coupon, the coupon management platform 105 determines there are no current negotiation rules, there are no current coupons or offers, and the like.

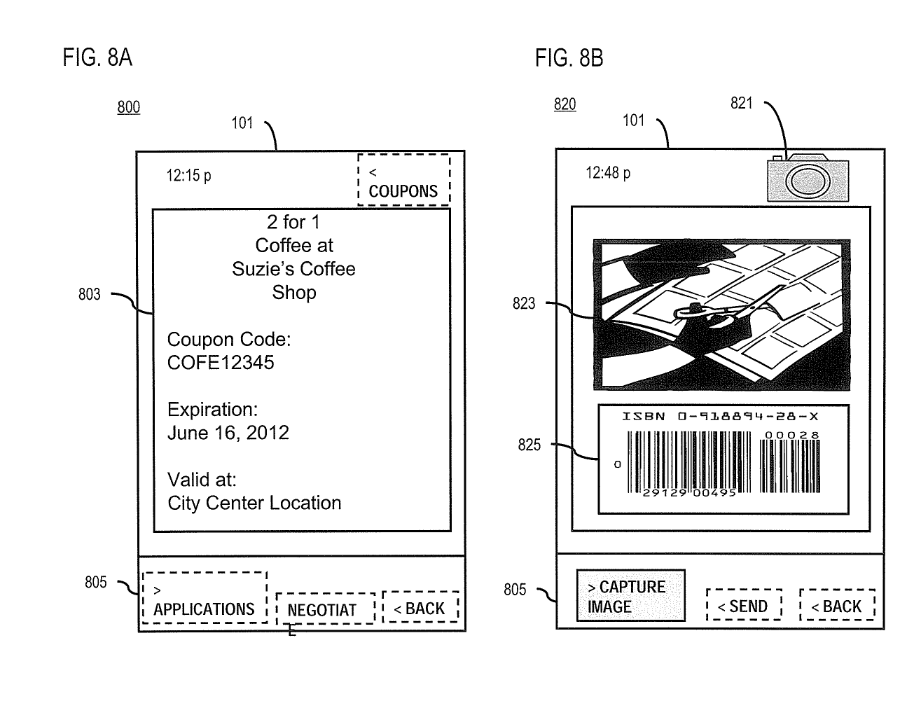

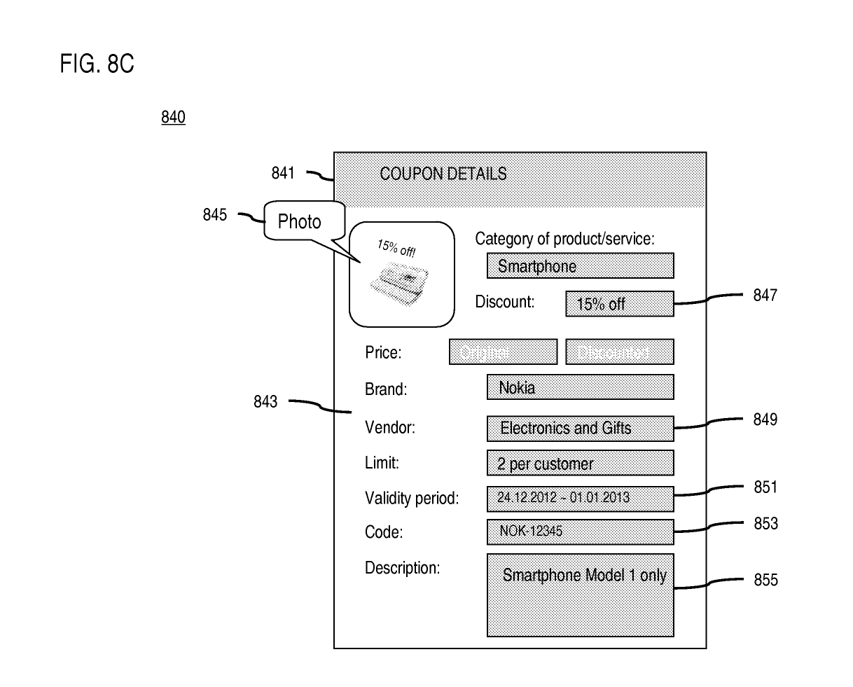

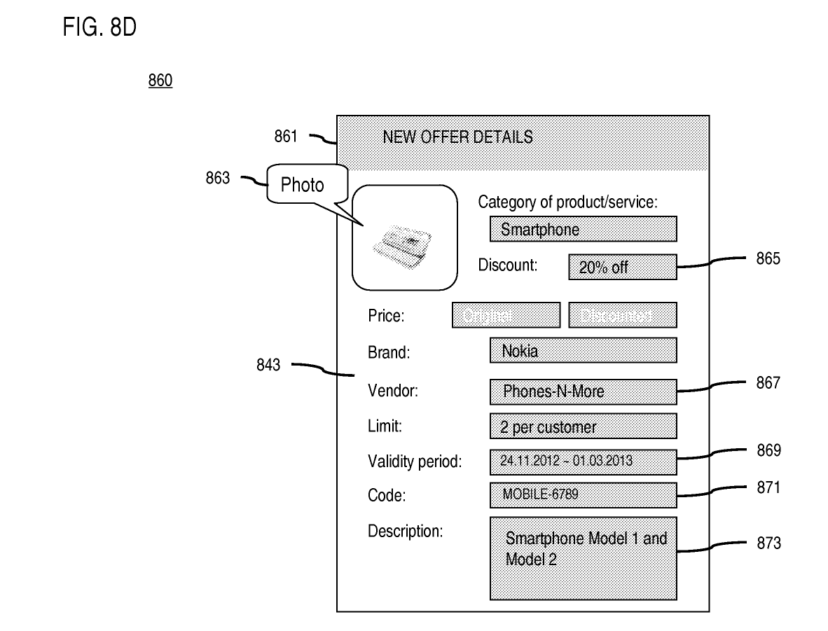

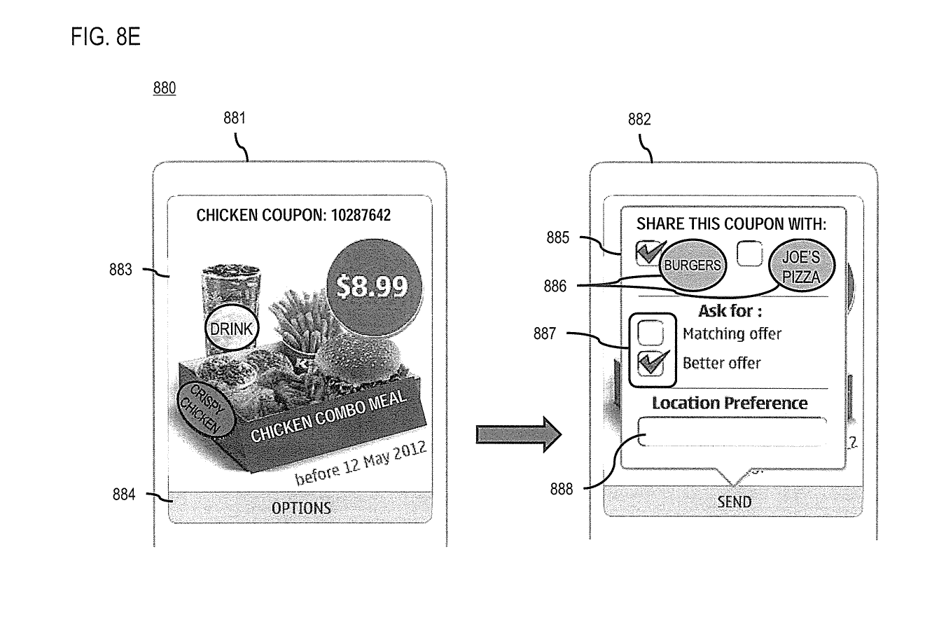

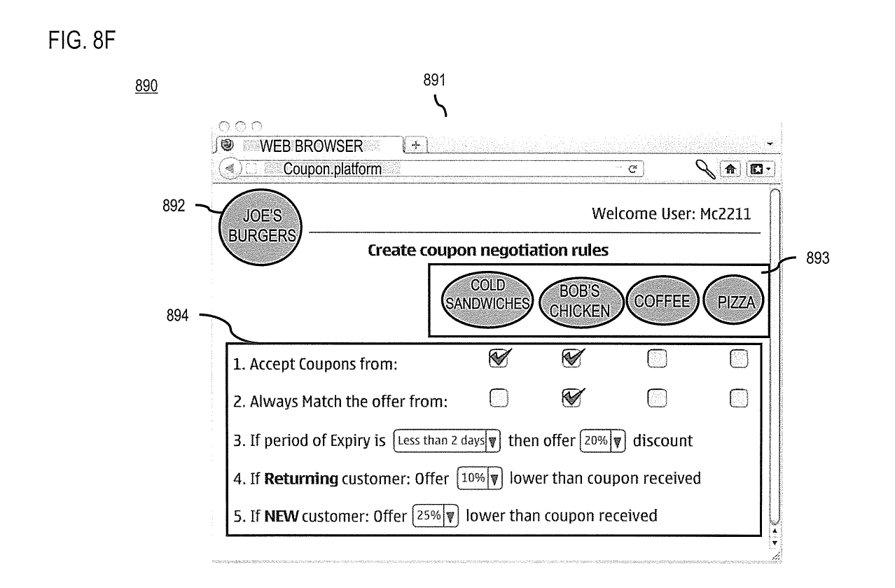

FIGS. 8A-8F are diagrams and user interface examples utilized in coupon rules and negotiation processes, according to various embodiments.

FIG. 8A depicts UI 800 wherein a UE 101 is utilized to submit a coupon (e.g., offer) 803 to the coupon management platform 105, wherein the coupon 803 may include various coupon information such as coupon offering (e.g., 2 for 1), product or service (e.g., coffee), vendor (e.g., Suzie's Coffee Shop), expiration date, a vendor location, and the like. Further, the user may take one or more actions at 805, for example, utilize one or more applications, submit for negotiation, and the like. FIG. 813 depicts UI 820 where a UE 101 is utilized to capture one or more images, via a camera device 821, of one or more coupons 823 (e.g., a coupon clipping) and/or coupon information 825 (e.g., a barcode), and the like, wherein a user of the UE 101 may further utilize the UE 101 to send the one or more coupon images to the coupon management platform 105 for one or more negotiations.

FIG. 8C depicts coupon template 840 showing coupon/offer detail 841 received by the coupon management platform 105 where one or more coupon/offer information are captured. In one embodiment, one or more user coupon details 843 may be captured (e.g., entered) by a user of the UE 101 and/or the applications 103 for presentation to the coupon management platform 105. For example, the coupon details may include an image 845 of a product (e.g., a cell phone), a category of product/service, a discount 847 (e.g., 15% off), a price, a brand, a vendor 849, any limitations (e.g., 2 per customer), a validity period 851, a coupon code 853, a description 855, and the like. In one embodiment, applications 103 process a coupon and/or coupon/offer information in order to determine one or more coupon details and provide/capture them into a coupon template. In one embodiment, the coupon details may be submitted as free text and/or multimedia messages via various messaging formats (e.g., SMS, MMS, etc.) In one embodiment, the coupon/offer detail 841 is presented by a first vendor and/or a service provider to the coupon management platform 105 for authentication, wherein the coupon/offer details 841 may be associated with a first coupon offered by the first vendor or by another vendor. For example, the first vendor may wish to authenticate the first coupon offered by another vendor before accepting it for redemption from a user (e.g., cross vendor authentication). In another example, one or more vendors may wish to authenticate one or more coupons/offers before accepting the one or more coupons for any negotiations (e.g., a coupon/offer needs to be valid before any negotiations).

FIG. 8D depicts coupon template 860 showing a new coupon/offer detail 861 presented by a service provider (e.g., to a user). In one embodiment, the coupon/offer detail may be associated with one or more negotiated and/or renegotiated coupons/offers. In one instance, the new coupon/offer detail 861 may be a negotiated second coupon in response to the first coupon 841 of FIG. 8C, wherein one or more terms of the second coupon 861 are different (e.g., negotiated). For example, the image 863 includes a product image similar to that of in the first coupon 841, however, a discount 865 is different (e.g., now at 20%), a new vendor 867 (e.g., Phone-N-More), a new validity period 869, a new code 871, and additional description information in 873 wherein an additional model (e.g., model 2) is now included in the new offer 861. In one embodiment, the coupon management platform 105 (e.g., based on one or more rules) may request for a user to accept one or more terms/conditions of a new coupon/offer before presenting the new coupon/offer to the user. In one embodiment, the coupon management platform 105 (e.g., based on one or more rules) may require to invalidate a coupon (e.g., a first coupon) before/after offering/validating a subsequent (e.g., a second, third, fourth, etc.) coupon to the user.

FIG. 8E depicts coupon template 880 showing UIs 881 and 882 including a new coupon and a request for negotiation of the coupon. In one embodiment, a user receives a coupon 883 (e.g., for a meal deal at a chicken fast food vendor), which the user would like to utilize for negotiation. Further, the user may utilize one or more UI application options 884 to select one or more negotiation options 885 for submitting the coupon 883 to the coupon management platform 105. For example, the user may specify and/or select from a list of available vendors and/or product types 886 and one or more specific negotiation parameters 887 (e.g., negotiate for a better offer) for the coupon management platform 105 to consider in the negotiations. Further, the user may specify other parameters such as a user location preference 888. In various embodiments, the coupon management platform 105 may present one or more other parameters for the user to consider, for example, other vendors, product types, locations, and the like.

FIG. 8F depicts coupon rules template 890 showing UI 891 including various options for generating one or more coupon negotiation and/or authentication rules associated with one or more vendors. In various embodiments, the coupon management platform 105 and/or various vendors may utilize the UI 891 and/or other templates for specifying and/or generating various negotiation and/or authentication rules. In one example, a vendor 892 may specify one or more other vendors and/or product types 893 from which the vendor 892 would like to consider associated coupons. Further, the vendor 892 may specify one or more options 894, for example, whether to accept and/or match coupons offered by the vendors 893. Additionally, one or more other parameters associated with coupons by the vendors 893 and/or by the vendor 892 may be specified, for example, to consider expiration date, returning customers, new customers, and the like. In various embodiments, various vendors may specify one or more parameters associated with one or more negotiation and/or authentication rules associated with the various vendors, and/or the coupon management platform 105 may analyze, compare, determine, and/or propose the one or more parameters.

The processes described herein for negotiating and authenticating coupons may be advantageously implemented via software, hardware, firmware, or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

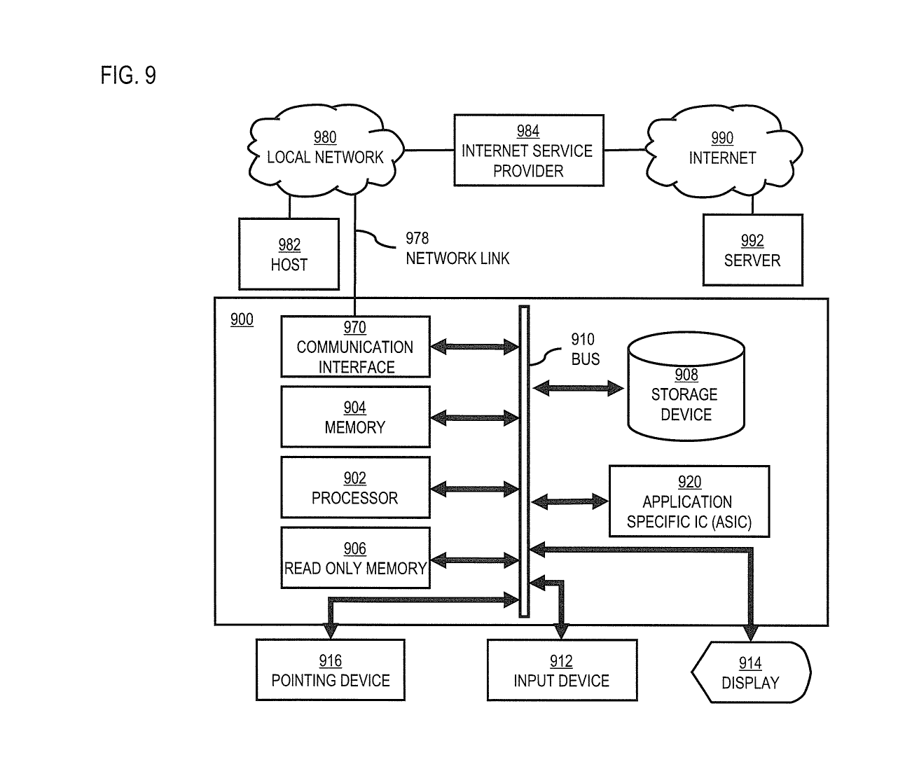

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to negotiate and authenticate coupons as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of negotiating and authenticating coupons.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to negotiating and authenticating coupons. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for negotiating and authenticating coupons. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for negotiating and authenticating coupons, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, which carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 113 for negotiating and authenticating coupons.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to negotiate and authenticate coupons as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of negotiating and authenticating coupons.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to negotiate and authenticate coupons. The memory 1005 also stores the data associated with or generated by the execution of the inventive steps.

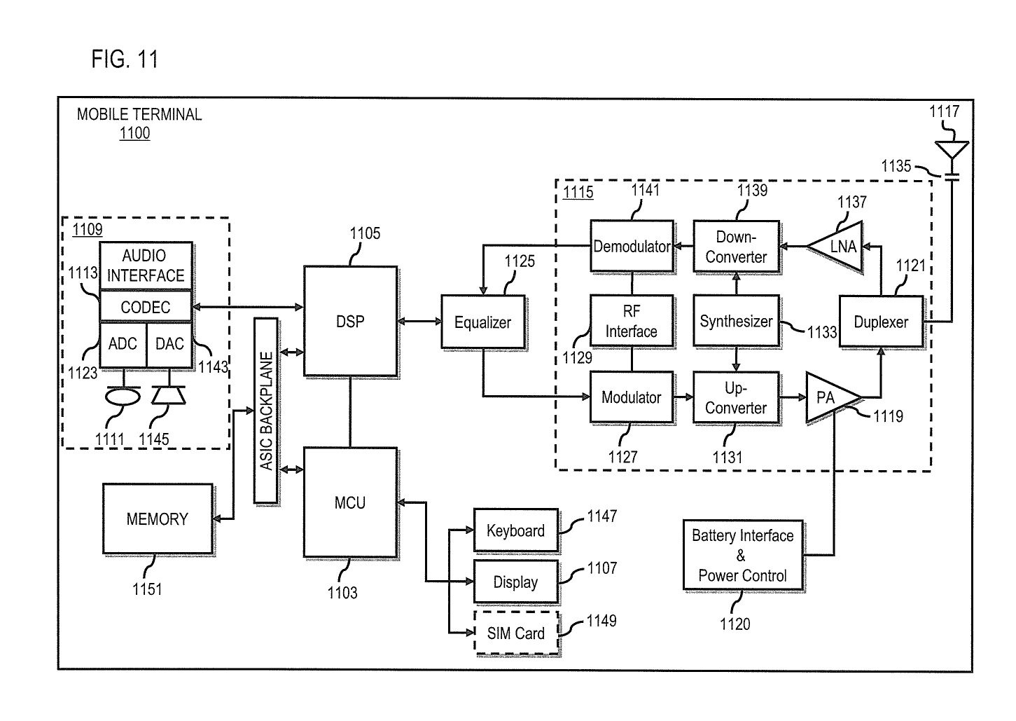

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of negotiating and authenticating coupons. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of negotiating and authenticating coupons. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to negotiate and authenticate coupons. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-38. (canceled)

39. A method comprising facilitating a processing of and/or processing (1) data and/or (2) information and/or (3) at least one signal, the (1) data and/or (2) information and/or (3) at least one signal based, at least in part, on the following:
at least one determination of a first offer information associated with at least one first coupon;
a processing of the first offer information against one or more negotiation rules to determine at least one second coupon; and
a presentation of the at least one second coupon, second offer information associated with the at least one second coupon, or a combination thereof.

40. The method of claim 39, wherein the (1) data and/or (2) information and/or (3) at least one signal are further based, at least in part, on the following:
a processing of the second offer information against one or more renegotiation rules associated with the at least one first coupon to determine at least one third coupon associated with at least one first vendor, at least one first user, or a combination thereof associated with the at least one first coupon.

41. The method of claim 39, wherein the (1) data and/or (2) information and/or (3) at least one signal are further based, at least in part, on the following:
a processing of the first offer information to determine a first offer value associated with the at least one first coupon; and
a processing of the second offer information to determine a second offer value with the at least one second coupon,
wherein the processing of the first offer information against the one or more negotiation rules to determine the at least one second coupon is based, at least in part, on the first offer value, the second offer value, or a combination thereof.

42. The method of claim 39, wherein the (1) data and/or (2) information and/or (3) at least one signal are further based, at least in part, on the following:
at least one determination of at least one category associated with the at least one first coupon,
wherein the determination of the at least one second coupon is further based, at least in part, on the at least one category.

43. The method of claim 39, wherein the (1) data and/or (2) information and/or (3) at least one signal are further based, at least in part, on the following:
at least one determination of contextual information, user preference information, profile information, or a combination thereof associated with a device, a user of the device, or a combination thereof that is presenting the at least one first coupon,
wherein the determination of the at least one second coupon is further based, at least in part, on the contextual information, the user preference information, the profile information, or a combination thereof.

44. The method of claim 39, wherein the (1) data and/or (2) information and/or (3) at least one signal are further based, at least in part, on the following:
an invalidation of the at least one first coupon based, at least in part, on the one or more negotiation rules, an acceptance of the at least one second coupon, or a combination thereof.

45. The method of claim 39, wherein the one or more negotiation rules are specified by at least one second vendor, at least one second user, or a combination thereof associated with the at least one second coupon.

46. The method of claim 39, wherein the (1) data and/or (2) information and/or (3) at least one signal are further based, at least in part, on the following:
at least one determination of one or more codes, one or more identifiers, or a combination thereof associated with the at least one first coupon, the at least one second coupon, or a combination thereof; and
an authentication of the at least one first coupon, the at least one second coupon, or a combination thereof based, at least in part, on the one or more codes, the one or more identifiers, or a combination thereof.

47. A method comprising:
determining a first offer information associated with at least one first coupon;
processing and/or facilitating a processing of the first offer information against one or more negotiation rules to determine at least one second coupon; and
causing, at least in part, a presentation of the at least one second coupon, second offer information associated with the at least one second coupon, or a combination thereof.

48. The method of claim 47, further comprising:
processing and/or facilitating a processing of the second offer information against one or more renegotiation rules associated with the at least one first coupon to determine at least one third coupon associated with at least one first vendor, at least one first user, or a combination thereof associated with the at least one first coupon.

49. An apparatus comprising:
at least one processor; and
at least one memory including computer program code for one or more programs,
the at least one memory and the computer program code configured to, with the at least one processor, cause the apparatus to perform at least the following,
determine a first offer information associated with at least one first coupon;
process and/or facilitate a processing of the first offer information against one or more negotiation rules to determine at least one second coupon; and
cause, at least in part, a presentation of the at least one second coupon, second offer information associated with the at least one second coupon, or a combination thereof.

50. The apparatus of claim 49, wherein the apparatus is further caused to:
process and/or facilitate a processing of the second offer information against one or more renegotiation rules associated with the at least one first coupon to determine at least one third coupon associated with at least one first vendor, at least one first user, or a combination thereof associated with the at least one first coupon.

51. The apparatus of claim 49, wherein the apparatus is further caused to:
process and/or facilitate a processing of the first offer information to determine a first offer value associated with the at least one first coupon; and
process and/or facilitate a processing of the second offer information to determine a second offer value with the at least one second coupon,
wherein the processing of the first offer information against the one or more negotiation rules to determine the at least one second coupon is based, at least in part, on the first offer value, the second offer value, or a combination thereof.

52. The apparatus of claim 49, wherein the apparatus is further caused to:
determine at least one category associated with the at least one first coupon,
wherein the determination of the at least one second coupon is further based, at least in part, on the at least one category.

53. The apparatus of claim 49, wherein the apparatus is further caused to:
determine contextual information, user preference information, profile information, or a combination thereof associated with a device, a user of the device, or a combination thereof that is presenting the at least one first coupon,
wherein the determination of the at least one second coupon is further based, at least in part, on the contextual information, the user preference information, the profile information, or a combination thereof.

54. The apparatus of claim 49, wherein the apparatus is further caused to:
cause, at least in part, an invalidation of the at least one first coupon based, at least in part, on the one or more negotiation rules, an acceptance of the at least one second coupon, or a combination thereof.

55. The apparatus of claim 49, wherein the one or more negotiation rules are specified by at least one second vendor, at least one second user, or a combination thereof associated with the at least one second coupon.

56. The apparatus of claim 49, wherein the apparatus is further caused to:
determine one or more codes, one or more identifiers, or a combination thereof associated with the at least one first coupon, the at least one second coupon, or a combination thereof; and
cause, at least in part, an authentication of the at least one first coupon, the at least one second coupon, or a combination thereof based, at least in part, on the one or more codes, the one or more identifiers, or a combination thereof.

57. The apparatus of claim 56, wherein the apparatus is further caused to:
cause, at least in part, an initiation of the authentication based, at least in part, on at least one request to redeem the at least one first coupon, the at least one second coupon, or a combination thereof.

58. The apparatus of claim 57, wherein the at least one request to redeem the at least one first coupon, the at least one second coupon, or a combination thereof is from at least one vendor, at least one user, or a combination thereof that is presented with the at least one first coupon, the at least one second coupon, or a combination thereof.
